(19) United States
(12) Patent Application Publication
(10) Pub. No.: US 2016/0062758 A1
(43) Pub. Date: Mar. 3, 2016

(54) METHOD, APPARATUS AND SYSTEM FOR PERFORMING MASS OPERATIONS IN A WIRELESS NETWORK

(71) Applicant: Nokia Solutions and Networks Oy, Espoo (FI)

(72) Inventors: Ram Lakshmi NARAYANAN, Pleasanton, CA (US); Somasundaram VELAYUTHAM, Sunnyvale, CA (US)

(21) Appl. No.: 14/468,565

(22) Filed: Aug. 26, 2014

(51) Int. Cl. G06F 9/445; H04W 8/14; H04W 16/18

(52) U.S. Cl. CPC G06F 8/65; H04W 16/18; H04W 8/14; H04W 80/12

(57) ABSTRACT

A method performed by a controller in a wireless network includes arranging a plurality of nodes into at least one group of nodes; selecting, from the plurality of nodes in one group of the at least one group of nodes, a first node; performing an operation at the first node; informing a next node from the plurality of nodes that the operation has been completed; performing the operation at the next node; repeating the informing and performing at a next node until the operation has been performed at each of the plurality of nodes.

### FIELD OF TECHNOLOGY

This disclosure relates generally to the field of wireless communication networks, and more particularly to a method, apparatus and system for performing mass operations in a wireless network.

### BACKGROUND

In current 3GPP/LTE Macro cell environments, operators typically perform tasks such as configuration changes or upgrade of base transceiver station (BTS) equipment one at a time. For example, an operator may start with one or two sites, study the impact of the new software on the site(s), and then continue to perform the operation, one site at a time, until the operations are complete, which can take several weeks to months. Such a sequence of steps involves coordination with field engineers, experts, operators, and others working in the environment. Similar operations when adopted for small cell deployment will take longer and will not scale, because due to traffic density in small cell environments, a higher concentration of small cells and coverage issues creates complex environments.

The number of sites in an operator network is likely going to increase due to penetration of small cell environments. For example, in an indoor environment or crowded location, several hundreds of small cells may be encountered. To update these environments, currently service engineers bring up one system at a time. When a patch upgrade then needs to be performed, for example, one upgrade per small cell site is done in a sequential manner, thus creating a pulsing effect. Such an upgrade operation can lead to network stabilization problems.

Current technologies such as Self Optimizing Networks (SON) have attempted to automate the configuration/sequencing process such that updates/operations can be performed network wide in a minimal amount of time.

### SUMMARY

A method performed by a controller in a wireless network includes arranging a plurality of nodes into at least one group of nodes; selecting, from the plurality of nodes in one group of the at least one group of nodes, a first node; performing an operation at the first node; informing a next node from the plurality of nodes in the one group that the operation has been completed; performing the operation at the next node; repeating the informing and performing at a next node until the operation has been performed at each of the plurality of nodes.

A method performed by a controller in a wireless network includes forming a collection of nodes, arranging the collection of nodes into a plurality of groups of nodes, receiving a software upgrade patch, preparing the software upgrade patch, selecting a first node from one of the plurality of groups of nodes, performing the software upgrade patch at the first node, informing at least one neighbor node of the first node that the software upgrade patch has been performed, performing, at the at least one neighbor node, the software upgrade patch, and informing an operator in the network that the software upgrade patch has been installed.

A wireless network system includes a plurality of nodes, a server, and a controller. The controller includes a processor and is configured to: arrange the plurality of nodes into at least one group of nodes, select, from the plurality of nodes in one group of the at least one group of nodes, a first node, perform an operation at the first node, inform a next node from the plurality of nodes that the operation has been completed, perform the operation at the next node, repeat the informing and performing at a next node until the operation has been performed at each of the plurality of nodes.

A controller in a wireless network includes a memory including at least one database, and a processor. The processor is configured to arrange a plurality of nodes into at least one group of nodes, select, from the plurality of nodes in one group of the at least one group of nodes, a first node, perform an operation at the first node, inform a next node from the plurality of nodes that the operation has been completed, perform the operation at the next node, repeat the informing and performing at a next node until the operation has been performed at each of the plurality of nodes.

### DESCRIPTION OF THE SEVERAL VIEWS OF THE DRAWINGS

To aid in the proper understanding of the present disclosure, reference should be made to the accompanying drawings, wherein:

FIG. 1 is a block diagram showing a 3GPP wireless network;

FIG. 2 is a block diagram illustrating zone or clusters of BTS and Servers in accordance with an embodiment of the present disclosure;

FIG. 3 is a flow chart illustrating a method in accordance with an embodiment of the present disclosure;

FIG. 4 is a flow chart illustrating a method in accordance with an embodiment of the present disclosure;

FIG. 5 is a signaling diagram illustrating the flow chart in FIG. 4 and in accordance with an embodiment of the present disclosure;

FIG. 6 is a block diagram illustrating parallel operation of a mass operation method in accordance with the present disclosure;

FIG. 7 is a block diagram illustrating a system in accordance with the present disclosure; and

FIG. 8 is a block diagram of a controller in accordance with an embodiment of the present disclosure.

### DETAILED DESCRIPTION

As briefly mentioned above, in current wireless networks, mass operations are generally performed one element at a time (i.e., one base transceiver station (BTS) at a time), which is neither a scalable solution nor time efficient. Such existing methods can also create uneven loads during the operation period due to side-effects on one cell that can then cascade to adjacent cells, which can lead to an unstable network configuration. Existing methods are not efficient for selecting cells/candidates for mass operations in wireless networks.

Some operators have utilized Self-Organized Networks (SON) in an attempt to address this situation, but such SON solutions fail to address optimal candidate selection for mass operations or network stabilization solutions. Although not discussed in any further detail herein, 3GPP has defined the SON framework with a primary goal of “zero maintenance” from an operator perspective. In other words, the goal of SON is automation: self-configuration, self-automation, and self-healing, for example. Currently, SON functionality is focused on basic bootstrapping and active learning of network conditions; many other aspects of SON are in the research/experimentation phase.

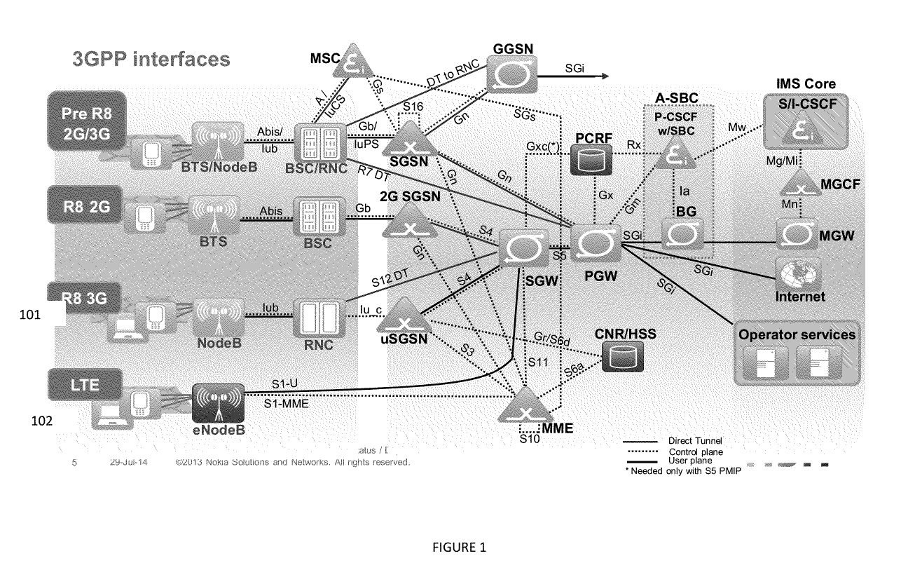

The present disclosure provides a method, apparatus and system that provides automatic cell/candidate selection for mass operations and that results in little to no network downtime during the operation. As will be described in further detail below, the present disclosure is complimentary to existing SON techniques and can be implemented as part of SON, though such implementation is not a requirement and the method, system and apparatus defined in this disclosure can be implemented in any network that performs mass operations. For example and as seen in FIG. 1, the present method, system and apparatus can be implemented in any wireless 3GPP interfaces illustrated therein, such as 3G 101 and LTE 102 macro and small cells, for example. It is further contemplated that the method, system and apparatus described herein can be implemented in 4G and beyond interfaces.

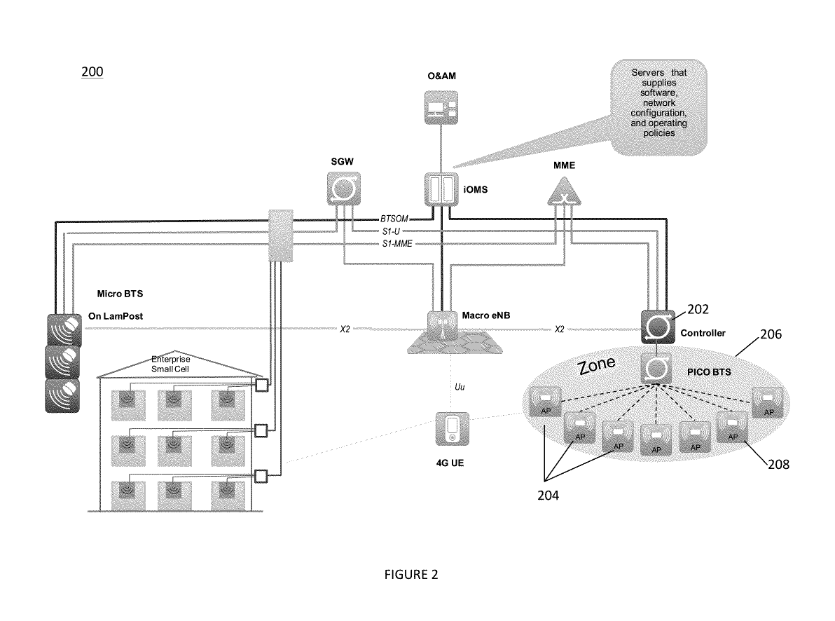

Turning now to FIG. 2, a diagram showing a wireless network 200 in accordance with the present disclosure is provided. As will be described in further detail below, the network 200 includes a controller 202 that is capable of, among other things, arranging/organizing a plurality of nodes 204 in the network into at least one zone/group 206 of nodes, and selecting a first node 208 within one of the groups to start a mass operation. For example, the mass operation could be a software upgrade patch, a map services mass operation (i.e., pushing map data to users in a specific group), or a BTS operation (such as a mass operation that changes the BTS power level settings or parameter settings). However, it is to be understood that the method in the present disclosure can be utilized to perform any operation that requires or affects groups of users in a network or a portion of a network element.

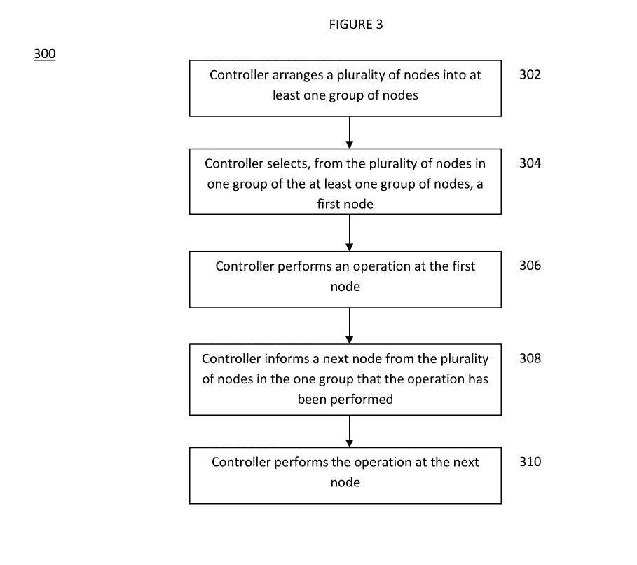

Referring now to FIG. 3, a flow chart depicting a method 300 in accordance with the present disclosure is illustrated. The method 300 can be performed by the controller 202 (see FIG. 2) At 302, the controller 202 arranges a plurality of nodes into at least one group of nodes, and at 304, the controller selects, from the plurality of nodes in one group of the at least one group of nodes, a first node. At 306, the controller performs an operation at the first node, such as a software upgrade patch or other mass operation. Upon completion of the operation at the first node, at 308 the controller informs a next node from the plurality of nodes in the one group that the operation has been completed. Accordingly, at 310, the controller performs the operation at the next node. The method 300 then repeats the informing and performing at a next node until the operation has been performed at each of the plurality of nodes in each of the groups of nodes.

As will be described in further detail below, the plurality of nodes can be a plurality of base transceiver stations or a plurality of user devices/subscribers, for example. The controller 202 arranges the nodes 204 into groups or constellations of nodes based on factors such as, but not limited to, a maximum number of users, a coverage area, traffic from each cell, coverage density of each cell, and time series analysis of traffic load in the cell, for example. The controller 202 can also obtain information from the plurality of nodes such that the configuration of each of the nodes is maintained. In other words, prior to the mass operation, each node exchanges information with the controller 202. The controller 202 stores the information and ensures that the node configurations and topology are preserved. Based on the formed constellations/groups, the nodes in each group are arranged in a sequence/priority, such that there is a first node and a last node, for example. As stated above, at step 306, the mass operation is performed at the first node. Upon completion, the controller informs the next node in the sequence that the first node has completed the operation, and then begins the operation at the next node, and so on, until the last node in the group has been operated upon. The controller can then perform the mass operation in the same manner in the remaining groups of nodes.

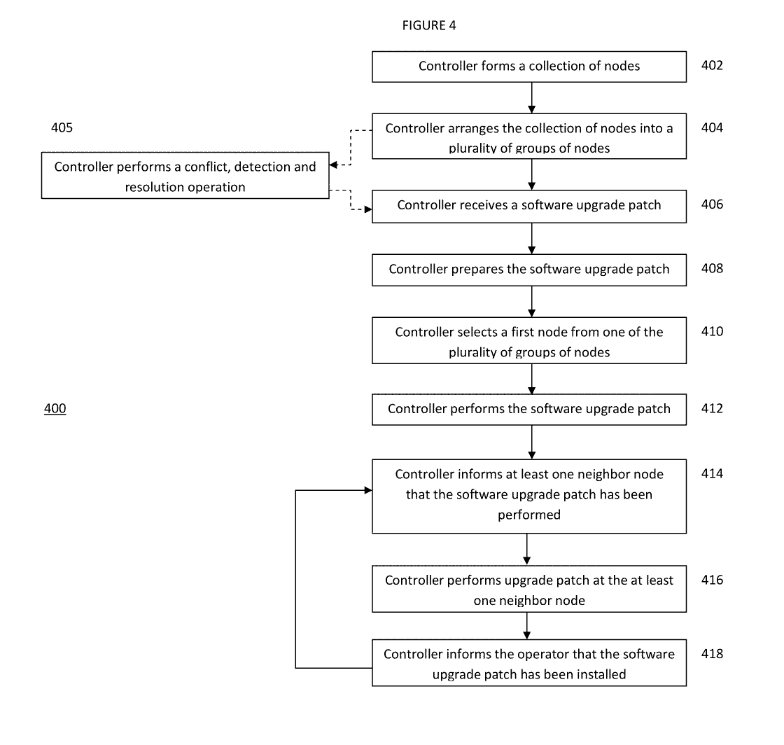

Referring next to FIG. 4, a specific example of the present method is described, in which a plurality of Base Transceiver Stations (BTS) are subject to a software patch upgrade. As described above, this method is for exemplary purposes only and it is understood that the present disclosure is not limited to software patch upgrades. Similar to method 300, method 400 is primarily performed by the controller 202. At 402, the controller 202 forms a collection of nodes, and at 404, the controller arranges the collection of nodes into a plurality of groups of nodes. For the purposes of this example, the nodes are base transceiver stations. Although additional factors may be considered, the controller arranges the collection of base stations based on at least one of a number of users, a coverage area, and a traffic rate. Based on the arranged groups of base stations, the controller arranges the base stations within each group in a constellation or sequential manner (i.e., a first BTS, a second/next BTS, and so on). Further, each base station group is arranged within the network such that parallel mass operations can occur (i.e., first BTS in group A, first BTS in group B, and first BTS in group C are all upgraded at the same time, then the next BTS in each group is upgraded, and so on until the mass operation is completed), which will be described in further detail below.

At 406, the controller 202 receives a software upgrade patch and proceeds to prepare the software upgrade patch at 408. During this point, the base stations can exchange their information with the controller such that their individual configurations are maintained/preserved. At 410, the controller selects a first node from one of the plurality of groups of nodes, and at 412 performs the software upgrade patch at the first node. At 414, the controller informs at least one neighbor node of the first node that the software upgrade patch has been performed. The controller performs, at the at least one neighbor node, the software upgrade patch at 416, and continues to perform the software upgrade patch at each neighbor node until all of the nodes in the group have been upgraded. At 418, the controller informs the operator (not shown) that the software upgrade patch has been installed. The method 400 can also include performing, at the controller, a conflict, detection and resolution operation to determine which software upgrade patch needs to be performed by the controller (405). This step can ensure that any upgrades/changes that need to be made are determined prior to any actual mass operations, which increases efficiency and reduces any network downtime caused by the mass operations.

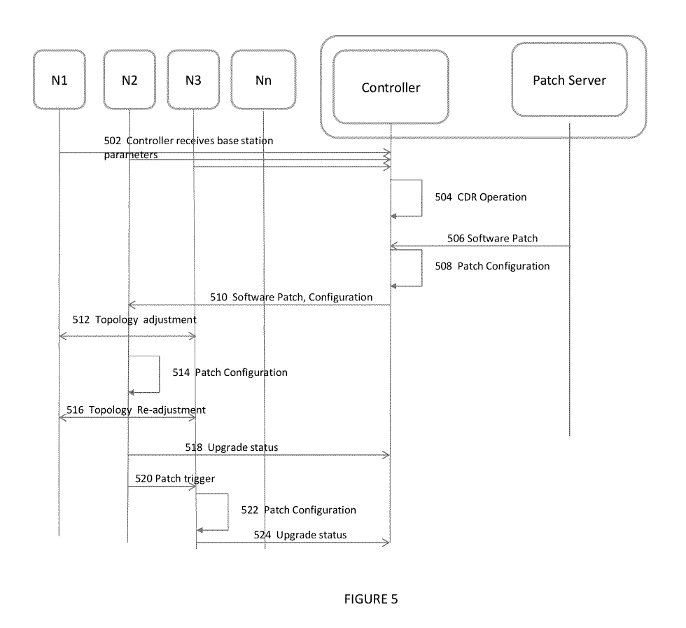

FIG. 5 illustrates the sequence of messages sent/received in the wireless network during the performance of the mass operation and in accordance with the method 400 described above. At 502, the controller automatically receives base station (i.e., node) status, current configuration and operational parameters, enabling the controller to make decisions throughout the operation. The controller can collect information from various sources such as, for example, traffic density over time on each cell in the network, subscriber density on each cell over time, location adjacency, and radio neighbor coverage. At 504, the controller can perform the conflict, detection and resolution (CDR) operation to ensure that any software upgrades/changes that should be made are determined prior to the start of any mass operation. Based on the information pushed to/received at the controller at 502, the controller can form BTS groups/constellations, which as described above with respect to method 400, are collections of BTS/nodes that are arranged in a sequential manner based on such factors as user numbers, coverage area, subscriber density, signaling traffic, topology, traffic density, for example. In other words, each group/collection will have a first node/BTS, a second node/BTS, and so on, where the controller arranges the BTS based on the information collected at the controller.

At 506, the controller receives the software patch that needs to be loaded to the BTS from a patch server. At 508, the controller prepares the patch configuration based on the groups/collections of BTS and their sequence within the groups. At 510, the controller chooses a node as a first patch configuration node. For the purposes of FIG. 5, N2 has been selected as the first patch configuration node/BTS. Once the first patch configuration node/BTS has been identified, in this case N2, it can directly instruct its neighbor nodes at 512 (i.e., N1 and/or N3), via the controller or directly (via an inter-BTS message) to readjust any topology coverage as N2 will be undergoing the patch operation. This re-adjustment of coverage ensures that the existing subscriber traffic that is currently being serviced by N2 is diverted to N1 and N3. At 514, the controller applies the patch configuration to N2, and any necessary conditions that need to be checked are monitored after the upgrade. For example, N2 can perform an initial self-test to ensure that the recently loaded patch is functioning correctly and is ready to come to normal operational state. Self-test varies depending upon the software patch or nature of operations. As an example, BTS has been upgraded to handle certain UE device specific features in those cases; after the patch upgrade, N2 will selectively accept connection of certain device types and ensure that those device specific features are being correctly acknowledged by BTS N2.

At 516, any necessary topology readjustments are applied to previous configuration settings, such that the network can return to a normal operating state. For example, after N2 has completed the patch upgrade, N2 can send an inter-BTS message or a message via the controller and request neighboring BTS N2 and N3 to reduce their power setting so that N2 can raise its power level and start providing coverage and taking traffic along with N1, and N3. The upgrade status is reported to the controller at 518 such that the controller can interrupt the mass operation if needed or “roll back” to a previous network/operational state if the upgrade status is not acceptable. At 520, after N2 (i.e., the first node) has completed the patch update, it informs its neighbors (i.e., N1, N3) of its current network configuration and requests that the neighbors perform the upgrade process. Accordingly, at 522, the neighbor nodes N1 and N3 perform the patch upgrade, and upon completion, report their status to the controller at 524. This process will continue until each of the nodes in each group has successfully been upgraded.

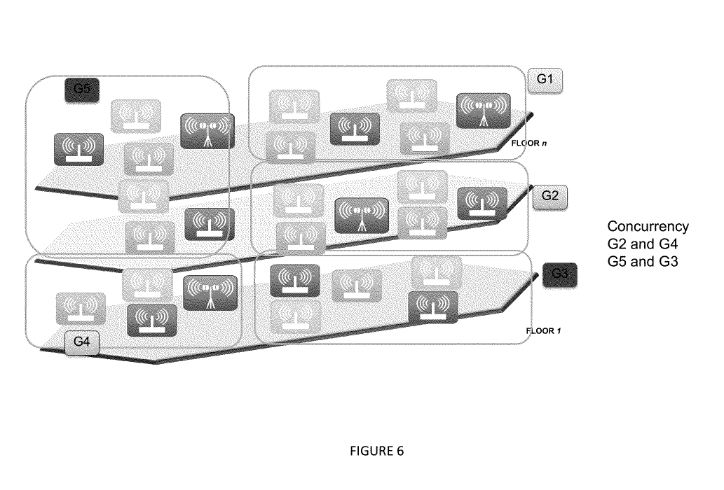

As briefly identified above, the present method and system allows for concurrent/parallel performance of mass operations in a wireless network. FIG. 6 illustrates such a parallel operation. For example, in FIG. 6, the nodes in Group G1 can be updated in accordance with the methods described above (and shown in FIGS. 3 and 4). After the nodes in G1 have been updated, they can instruct the nodes in groups G2 and G4 to update concurrently/in parallel. After groups G2 and G4 have been upgraded, they can instruct neighboring node groups G3 and G5 to perform the update. In another example, such as in a high-rise building, each floor may include a group of nodes, and each group may include a plurality of nodes. In another example, such as in a high-rise building, each floor may include a group of nodes, and each group may include a plurality of nodes. In accordance with the present disclosure, the controller can arrange each of the nodes in each group in a sequential manner, such that group 1 (i.e., floor 1) includes nodes 1-10, group 2 (i.e., floor 2) includes nodes 1-10, and so on. In the parallel mass operation, the controller can instruct node 1 in each group (i.e., node 1 in floor 1, node 1 in floor 2, node 1 in floor 3, etc.) to concurrently start the mass operation. In other words, each node 1 on each floor will be performing the mass operation at the same time. Upon completion of the operation, each node 1 in each group can inform their respective neighbors (i.e., node 2 in floor 1, node 2 in floor 2, node 2 in floor 3, etc.) to concurrently perform the mass operation. This process can continue on until each of the nodes in each group have been upgraded. It is contemplated that such parallel/concurrent mass operations reduce network downtime, reduce the duration of mass operations, and reduce any disruption to traffic and/or user movements.

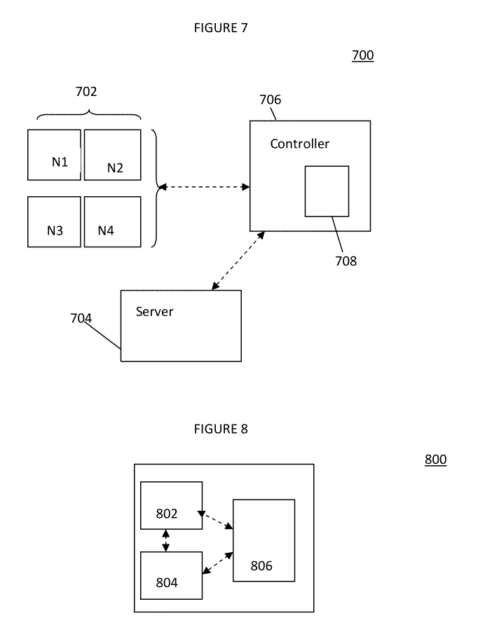

Referring next to FIG. 7, a wireless network system 700 is illustrated and includes a plurality of nodes 702, a server 704, and a controller 706. The controller 706 includes a processor 708 and is configured to perform the steps of the methods 300 and 400 described in detail above. For example, the controller 706 is configured to arrange the plurality of nodes 702 into at least one group of nodes, select, from the plurality of nodes in one group of the at least one group of nodes, a first node, perform an operation at the first node, inform a next node from the plurality of nodes that the operation has been completed, perform the operation at the next node, repeat the informing and performing at a next node until the operation has been performed at each of the plurality of nodes. As described above, the plurality of nodes can include at least one of a plurality of base transceiver stations, a plurality of user devices, and a plurality of subscribers, although it is recognized that this list is non-limiting and non-exhaustive. For example, the controller 706, when configured to perform an operation in accordance with methods 300, 400, can be configured to make changes to the plurality of base transceiver stations. Alternatively, the controller 706, when configured to perform an operation in accordance with the methods 300, 400, can be configured to push updates to the plurality of user devices.

FIG. 8 illustrates a block diagram of a controller 800 in accordance with the present disclosure and the previously described controllers 202 and 706. The controller 800 is provided in a wireless network and includes a memory 802 including at least one database 804, and a processor 806. As described in greater detail above with respect to FIGS. 3 and 4, the controller 800, in conjunction with the processor 806, is configured to arrange a plurality of nodes into at least one group of nodes, select, from the plurality of nodes in one group of the at least one group of nodes, a first node, perform an operation at the first node, inform a next node from the plurality of nodes that the operation has been completed, perform the operation at the next node, repeat the informing and performing at a next node until the operation has been performed at each of the plurality of nodes.

As discussed above, the present disclosure provides a method for forming constellations/groups and selecting possible candidates for different mass operations such as upgrades and configuration changes. The present method, system and controller make minimal changes to the network during mass operations. The selected candidates and subsequent constellation formation is dynamic in nature and operational-dependent. The present disclosure enables concurrent operation at different parts of the network topology and rapid network convergence. Further, the present disclosure can be added to existing SON frameworks, is compatible with cellular technology 4G and beyond, and is suitable for small cell networks. Another advantage of the present disclosure is that it does not require that operations be performed based on geographical region or topology dependence. In addition, the present disclosure supports parallel operations at different parts of the topology, thus increasing mass operation efficiency. Also, during the mass operations utilizing the present disclosure, there is little to no network downtime.

It is further contemplated that the present disclosure can be self-learning. In other words, as the controller performs the CDR, constellation and arrangement of the nodes/groups, it learns configuration, operational statistical information, and network information that can allow it to automatically schedule suitable operations when requested by a network operator. The controller can combine and analyze various data sets such as traffic from each network cell, coverage density of each network cell, time series analysis of traffic load, for example, to define the constellations/groups for each mass operation.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present invention includes a computer program product comprising a computer-readable storage medium bearing computer program code embodied therein for use with a computer, the computer program code comprising code for performing any of the methods and variations thereof as previously described. Further, the present invention also includes an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the disclosure are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

The following abbreviations that may be found in the specification and/or the drawing figures are defined as follows:

3GPP Third Generation Partnership Project

BTS Base Transceiver Station

CDR Conflict, Detection and Resolution

LTE Long Term Evolution

SON Self-Organizing Network

UE User Equipment

1. A method performed by a controller in a wireless network, comprising:
arranging a plurality of nodes into at least one group of nodes;
selecting, from the plurality of nodes in a group of the at least one group of nodes,
a first node;
performing an operation at the first node;
informing a next node from the plurality of nodes in the group that the operation has been completed;
performing the operation at the next node;
repeating the informing and performing at a next node until the operation has been performed at each of the plurality of nodes.

2. The method of claim 1 wherein the plurality of nodes are a plurality of base transceiver stations.

3. The method of claim 1 wherein the arranging comprises forming a node constellation.

4. The method of claim 3 wherein forming a node constellation comprises categorizing the plurality of nodes based on at least one of a maximum number of users, a maximum coverage area, and a maximum traffic area.

5. The method of claim 4 further comprising arranging the plurality of nodes in a sequence based on the categorizing.

6. The method of claim 1 further comprising, prior to performing an operation at the first node: exchanging, at the plurality of nodes, information such that a configuration of each of the plurality of nodes is maintained.

7. The method of claim 1 wherein arranging a plurality of nodes includes arranging a plurality of user devices configured to receive data from the controller.

8. A method performed by a controller in a wireless network, comprising:
forming a collection of nodes;
arranging the collection of nodes into a plurality of groups of nodes;
receiving a software upgrade patch;
preparing the software upgrade patch;
selecting a first node from one of the plurality of groups of nodes;
performing the software upgrade patch at the first node;
informing at least one neighbor node of the first node that the software upgrade patch has been performed;
performing, at the at least one neighbor node, the software upgrade patch; and
informing an operator in the network that the software upgrade patch has been installed.

9. The method of claim 8 wherein the collection of nodes is a collection of base transceiver stations.

10. The method of claim 9 wherein arranging the collection of nodes into a plurality of groups further comprises categorizing the base transceiver stations based on at least one of a number of users, a coverage area, and a traffic rate.

11. The method of claim 10 further comprising arranging the plurality of nodes in a sequence based on the categorizing.

12. The method of claim 8 further comprising, prior to performing the software upgrade patch at the first node: exchanging, at the plurality of groups of nodes, information such that a configuration of each of the plurality of nodes is maintained.

13. The method of claim 8 further comprising performing, at the controller, a conflict, detection and resolution operation to determine the software upgrade patch that needs to be performed at the controller.

14. The method of claim 8 wherein performing, at the at least one neighbor, the software upgrade patch, comprises: concurrently performing the software upgrade patch at the at least one neighbor.

15. The method of claim 8 wherein forming a collection of nodes comprises forming a collection of user devices in the wireless network.

16. A wireless network system comprising:
a plurality of nodes;
a server;
a controller, the controller including a processor and configured to:
arrange the plurality of nodes into at least one group of nodes;
select, from the plurality of nodes in a group of the at least one group of nodes, a first node;
perform an operation at the first node;
inform a next node from the plurality of nodes in the group that the operation has been completed;
perform the operation at the next node;
repeat the informing and performing at a next node until the operation has been performed at each of the plurality of nodes.

17. The system of claim 16 wherein the plurality of nodes includes at least one of a plurality of base transceiver stations, a plurality of user devices, and a plurality of subscribers.

18. The system of claim 17 wherein the controller, when configured to perform an operation, is configured to make changes to the plurality of base transceiver stations.

19. The system of claim 17 wherein the controller, when configured to perform an operation, is configured to push updates to the plurality of user devices.

20. A controller in a wireless network, comprising:
a memory including at least one database; and
a processor, wherein the processor is configured to:
arrange a plurality of nodes into at least one group of nodes;
select, from the plurality of nodes in one group of the at least one group of nodes, a first node;
perform an operation at the first node;
inform a next node from the plurality of nodes that the operation has been completed;
perform the operation at the next node;
repeat the informing and performing at a next node until the operation has been performed at each of the plurality of nodes.
